(19) United States
(12) Patent Application Publication
(10) Pub. No.: US 2013/0036852 A1
(43) Pub. Date: Feb. 14, 2013

(54) OPERATION UNIT

(71) Applicants: Masahito HISADA, Aichi (JP); Yoshinori TAKANO, Aichi (JP)

(72) Inventors: Masahito HISADA, Aichi (JP); Yoshinori TAKANO, Aichi (JP)

(73) Assignee: KABUSHIKI KAISHA TOKAI RIKA DENKI SEISAKUSHO, Aichi (JP)

(21) Appl. No.: 13/565,066

(22) Filed: Aug. 2, 2012

(30) Foreign Application Priority Data
Aug. 8, 2011 (JP) 2011-173237

(51) Int. Cl. G05G 1/10

(52) U.S. Cl. 74/504

(57) ABSTRACT

An operation unit includes a case and an operation member molded integrally through injection molding. The operation member includes an outer surface and a slide portion supported by the case. The slide portion is slidable and movable relative to the case. The operation member further includes a knob operated by an operator, a parting line formed continuously from the slide portion to the knob along the outer surface, and a ridge line formed on the outer surface. At least part of the parting line is formed along the ridge line.

### CROSS-REFERENCE TO RELATED APPLICATIONS

This application is based upon and claims the benefit of priority from prior Japanese Patent Application No. 2011-173237, filed on Aug. 8, 2011, the entire contents of which are incorporated herein by reference.

### BACKGROUND OF THE INVENTION

The present invention relates to an operation unit provided with an operation member including an outer surface having a parting line.

A typical vehicle includes electrical devices such as an air conditioner and audio equipment. An operation unit, which is arranged in the passenger compartment, is operated to control such a device. Japanese Laid-Open Patent Publication No. 2010-122992 describes an example of such an operation unit.

The operation unit of Japanese Laid-Open Patent Publication No. 2010-122992 includes a case and an operation member, which is held in a state slidable and movable relative to the case. Referring to FIG. 8, a cylindrical operation member 80 includes a slide portion 81, a step portion 82, and a knob 83. The slide portion 81 is movable relative to the case. The step portion 82 is continuous with an upper part of the slide portion 81 and has a smaller diameter than the slide portion 81. The knob 83 is continuous with an upper part of the step portion 82 and has a smaller diameter than the step portion 82. Knurls 84 are formed on the outer surface of the knob 83 to prevent slipping. Each knurl 84 is pyramidal. A lubricant such as grease is applied to the outer surface of the slide portion 81 to reduce friction between the slide portion 81 and the case. This allows for smooth rotation of the operation member 80 relative to the case.

The operation member 80 of Japanese Laid-Open Patent Publication No. 2010-122992 is injection molded. Injection molding is performed by filling a plurality of molds with thermoplastic resin. This allows for easy molding of a product having a complicated shape. However, an elevated line referred to as a parting line is formed on a molded product at where molds meet. Four parting lines PL are formed on the outer surface of the operation member 80. The four parting lines PL are formed at equal intervals in the circumferential direction. Each parting line PL extends straight from the slide portion 81 to the knob 83.

The lubricant applied to the slide portion 81 may be transferred to the knob 83 along the parting lines PL due to capillary action. When the lubricant is transferred to the knob 83, the lubricant may stick to a user's hand as the user operates the knob 83.

To solve this problem, a through hole 85 extending through the operation member 80 from its outer surface to its inner surface is arranged on each of the four parting lines PL between the knurls 84 and the slide portion 81. The through holes 85 block the capillary action of the lubricant along the parting lines PL.

Such an operation unit often includes a light source arranged in the operation member 80. This forms a path of light in the operation member 80 and illuminates a panel (not shown), which is arranged in the vicinity of the distal end of the operation member 80, from the rear. The light leaking through the panel allows the user to recognize the operation positions or the like of the operation member 80 especially in the nighttime. However, when the light source is arranged in the operation member 80, the light emitted from the light source may also leak from the through holes 85. The leaked light will illuminate the surrounding of the operation member. This is not preferable from an aesthetic viewpoint. Japanese Laid-Open Patent Publication No. 2010-122992 illustrates that the through holes 85 may be replaced by openings or recesses that do not extend through the wall of the operation member 80. However, in this case, each parting line PL remains connected and is not split apart. That is, the capillary action of the lubricant that occurs along the parting line PL is not blocked. Thus, there is a demand for development of an operation unit that suppresses the occurrence of a capillary action without the through holes 85 and prevents lubricant from leaking to the exterior.

### SUMMARY OF THE INVENTION

One aspect of the present invention is an operation unit including a case and an operation member molded integrally through injection molding. The operation member includes an outer surface and a slide portion supported by the case. The slide portion is slidable and movable relative to the case. The operation member further includes a knob operated by an operator, a parting line formed continuously from the slide portion to the knob along the outer surface, and a ridge line formed on the outer surface. At least part of the parting line is formed along the ridge line.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view showing a passenger compartment including operation units;

FIG. 2A is a cross-sectional view showing an operation unit according to one embodiment of the present invention;

FIG. 2B is an enlarged cross-sectional view of FIG. 2A showing hooks;

FIG. 3A is a perspective view showing an operation member of the operation unit;

FIG. 3B is an enlarged view of FIG. 3A showing a knob;

FIG. 3C is an enlarged view of FIG. 3A showing a region from a mounted portion to a step portion

FIG. 3D is an enlarged view of FIG. 3A showing a region from the step portion to a slide portion;

FIG. 4 is a cross-sectional view of a mold used in a process for manufacturing the operation member;

FIG. 5A is a cross-sectional view taken along line A-A in FIG. 4;

FIG. 5B is a cross-sectional view taken along line B-B in FIG. 4;

FIG. 6 is a perspective view showing a modification of the operation member;

FIG. 7 is a cross-sectional view showing a process for manufacturing the operation member of FIG. 6 taken along a plane corresponding to line B-B in FIG. 4; and

FIG. 8 is a perspective view showing an operation member of the prior art.

### DETAILED DESCRIPTION OF THE INVENTION

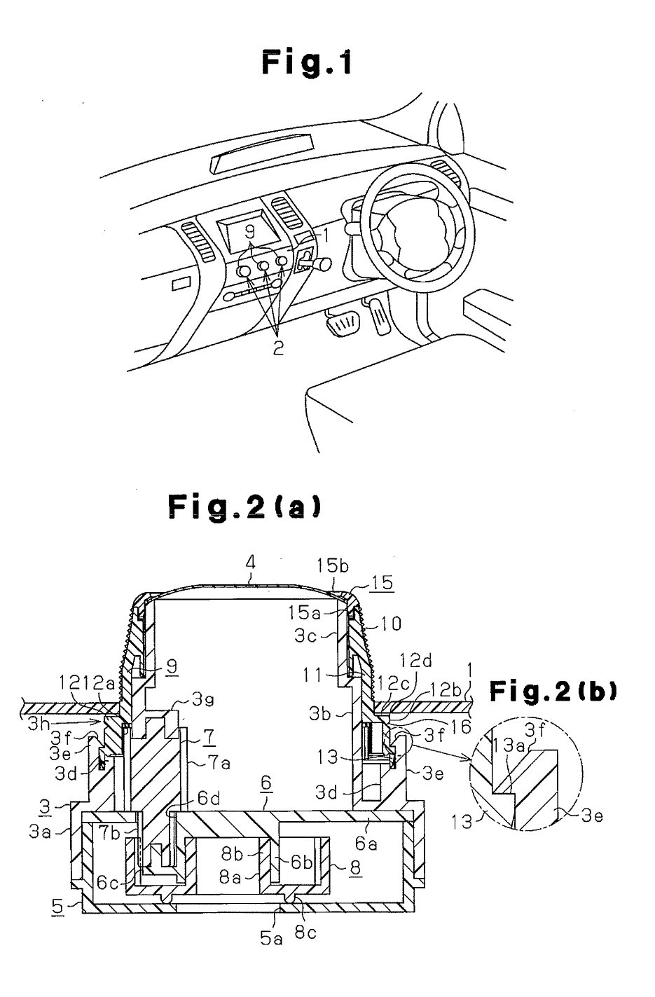

An operation unit according to one embodiment of the present invention will now be described with reference to FIGS. 1 to 5. The operation unit is used to operate an air conditioner for a vehicle.

Referring to FIG. 1, an instrument panel 1 is arranged in a passenger compartment. Operation units 2 are arranged on the instrument panel 1 to adjust the temperature, change the direction of a blowing port, and adjust the airflow.

Referring to FIG. 2A, each operation unit 2 includes a case 3. The case 3 includes a main body portion 3a, a cylindrical mounting portion 3b, which extends upward from the main body portion 3a, and a cylindrical distal portion 3c, which extends upward from the mounting portion 3b. The main body portion 3a is tetragonal. The distal portion 3c has a smaller outer diameter than the mounting portion 3b. The interior of the mounting portion 3b is in communication with the interior of the main body portion 3a. The interior of the distal portion 3c is in communication with the mounting portion 3b. The case 3 includes an opening at the upper part of the distal portion 3c and an opening at the lower part of the main body portion 3a. A panel 4 closes the opening of the distal portion 3c. A housing 5 closes the opening of the main body portion 3a. The housing 5 has a U-shaped cross-section and includes an upper opening and a bottom wall. A cable hole 5a extends through the central part of the bottom wall in the housing 5. The case 3 is fixed to the vehicle so that the distal portion 3c projects into passenger compartment from the instrument panel 1.

A rotation supporting portion 3d is formed around the mounting portion 3b on an upper surface of the main body portion 3a. The rotation supporting portion 3d has a larger inner diameter than the outer diameter of the mounting portion 3b. Further, four hooking portions 3e are arranged around the rotation supporting portion 3d on the upper surface of the main body portion 3a. FIG. 2A shows only two of the hooking portions 3e that are located on opposite sides of the mounting portion 3b in the radial direction. The hooking portions 3e are separated from the rotation supporting portion 3d. Further, the hooking portions 3e are arranged at equal angular intervals along a circle extending around the mounting portion 3b. Each hooking portion 3e includes a distal part from which a hook 3f extends toward the mounting portion 3b. The rotation supporting portion 3d has a height from the upper surface of the main body portion 3a that is less than the distance from the upper surface of the main body portion 3a to the hook 3f of the hooking portion 3e.

A bearing 3g is formed on an inner circumferential surface of the mounting portion 3b. A communication hole 3h is formed in the lower end of the mounting portion 3b communicating the inner side and outer side of the case 3. The communication hole 3h is adjacent to the bearing 3g.

An insulator 6 is accommodated in the void formed by the main body portion 3a of the case 3 and the housing 5. The insulator 6 includes a flat fastening portion 6a and a cylindrical supporting portion 6b. The fastening portion 6a extends along an inner bottom surface of the main bottom surface of the main body portion 3a of the case 3. The supporting portion 6b extends downward from the lower surface of the fastening portion 6a. A support shaft 6c is formed on the outer circumferential surface of the supporting portion 6b. The fastening portion 6a includes an accommodation hole 6d that faces toward the support shaft 6c in the axial direction of the supporting portion 6b. The insulator 6 is fixed to the inner bottom surface of the main body portion 3a in the case 3 so that the support shaft 6c is aligned with the bearing 3g in the axial direction of the mounting portion 3b (supporting portion 6b).

The bearing 3g of the case 3 and support shaft 6c of the insulator 6 rotatably support a reduction gear 7. The supporting portion 6b of the insulator 6 rotatably supports an internal gear 8. The reduction gear 7 includes a first gear portion 7a and a second gear portion 7b. The first gear portion 7a includes teeth extending from its outer circumferential surface. The second gear portion 7b has a smaller diameter than the first gear portion 7a. The second gear portion 7b includes teeth extending from its outer circumferential surface. The first gear portion 7a and the second gear portion 7b are formed integrally on the same shaft. The teeth of the first gear portion 7a are arranged in correspondence with the hooks 3f of the case 3. The second gear portion 7b is engaged with the internal gear 8. The internal gear 8 is cylindrical, closed at the bottom, and open toward the insulator 6. An insertion hole 8a extends through the central part of the bottom wall in the internal gear 8. A cylindrical coupling portion 8b extends toward the insulator 6 around the insertion hole 8a. The coupling portion 8b has an inner diameter that is the same as the diameter of the insertion hole 8a and an outer diameter that is slightly smaller than the inner diameter of the supporting portion 6b of the insulator 6. An annular projection 8c is arranged on the bottom of the insulator 6. In a state in which the coupling portion 8b is arranged in the supporting portion 6b of the insulator 6 and the distal surface of the annular projection 8c is in contact with the bottom surface of the housing 5, the insulator 6 and the housing 5 rotatably support the internal gear 8. A cable (not shown) is arranged in the coupling portion 8b. The cable extends out of the housing through the cable hole 5a of the housing 5 and is connected to the air conditioner.

An operation member 9 is mounted on the mounting portion 3b of the case 3. Injection molding is performed to form the operation member 9. The operation member 9 is cylindrical and has two open ends. Further, the operation member 9 includes a knob 10, a mounted portion 11, a step portion 12, and a slide portion 13. The knob 10 has an inner diameter that is slightly greater than the outer diameter of the distal portion 3c. The mounted portion 11 has an inner diameter that is slightly greater than the outer diameter of the mounting portion 3b. The mounted portion 11 has an outer diameter that is greater than the outer diameter of the knob 10. The step portion 12 has an outer diameter that is greater than the outer diameter of the mounted portion 11. Further, the outer diameter of the step portion 12 is slightly less than the distance between the hooks 3f of two of the hooking portions 3e arranged on opposite sides of the mounting portion 3b in the radial direction. The slide portion 13 has an outer diameter that is greater than the outer diameter of the mounted portion 11. Further, the outer diameter of the slide portion 13 is greater than the distance between the hooks 3f of two of the hooking portions 3e arranged on opposite sides of the mounting portion 3b in the radial direction and slightly smaller than the distance between the two hooking portions 3e. The slide portion 13 has an inner diameter that is slightly greater than the outer diameter of the rotation supporting portion 3d.

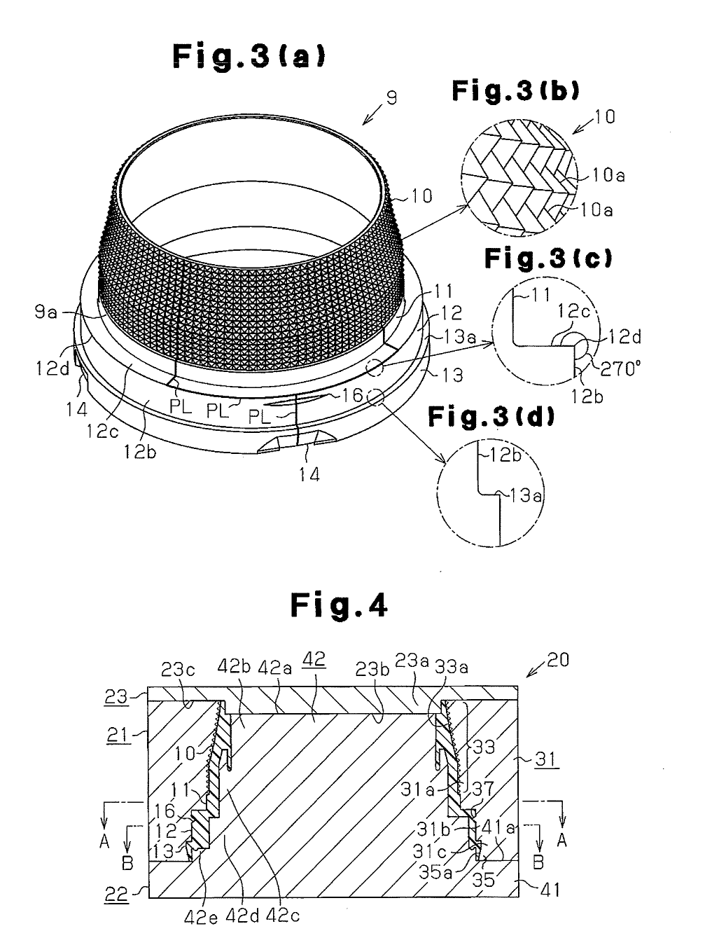

The operation member 9 is mounted on the mounting portion 3b in a state in which the slide portion 13 is arranged at the inner side of the hooking portions 3e of the case 3. Referring to FIG. 2B, an upper surface 13a of the slide portion 13 located near the step portion 12 is engaged with the hooks 3f of the hooking portions 3e. This secures the operation member 9, in a rotatable state, to the mounting portion 3b. As shown in FIG. 3, the slide portion 13 includes four thin parts 14 arranged at equal angular intervals in the circumferential direction. Each thin part 14 has a thickness that gradually decreases at lower locations. Alignment of the thin parts 14 with the hooks 3f facilitates the engagement of the upper surface 13a of the slide portion 13 with the hooks 3f.

As shown in FIG. 2A, teeth 12a extend from the inner surface of the step portion 12. When the operation member 9 is mounted on the mounting portion 3b, the teeth 12a are arranged in correspondence with the hooks 3f of the mounting portion 3b and engaged with the first gear portion 7a of the reduction gear 7.

A resin knob top 15 is coupled to the distal part of the knob 10. The knob top 15 includes a coupling portion 15a, which is cylindrical and coupled to the inner surface of the knob 10, and an annular flange 15b, which is continuous with the upper part of the coupling portion 15a. The flange 15b has an inner diameter that is greater than the outer diameter of the panel 4. Further, the flange 15b has an outer diameter that is the same as the outer diameter of the distal part of the mounted portion 11. When the knob top 15 is coupled to the operation member 9, the flange 15b covers the distal part of the knob 10 and the peripheral part of the panel 4.

The outer diameter of the knob 10 decreases at upper locations. As shown in FIGS. 2A and 3B, pyramidal knurls 10A are formed on the entire outer circumferential surface of the knob 10 to prevent slipping.

As shown in FIG. 3A, parting lines PL are formed in the outer surface 9a of the operation member 9 extending over the slide portion 13, the step portion 12, the mounted portion 11, and the knob 10. Each parting line PL is an elevated line formed where molds meet when integrally molding the operation member 9 during injection molding. In the present example, two parting lines PL are formed at locations corresponding to two opposing ones of the four thin parts 14 (only one shown in the perspective view of FIG. 3A). The parting line PL extends upward and is continuous with the step portion 12.

The upper surface of the step portion 12 includes an outer circumferential surface 12b, which is continuous with the upper surface 13a of the slide portion 13, and an upper surface 12c, which is continuous with an upper part of the outer circumferential surface 12b. As shown in FIG. 3C, a ridge line 12d is formed as a peak extending continuously at the boundary between the outer circumferential surface 12b and the upper surface 12c throughout the entire circumference of the step portion 12. The outer circumferential surface 12b and the upper surface 12c are arranged at a major angle of 270°. A major angle is an angle between 180° and 360°. As shown in FIG. 3A, in the step portion 12, parting lines PL are formed on the outer circumferential surface 12b, the upper surface 12c, and the ridge line 12d. In detail, the parting lines PL formed on the outer circumferential surface 12b extend in the vertical direction. Each of the parting lines PL on the outer circumferential surface 12b have a lower part that is continuous with a parting line PL formed on the upper surface 13a of the slide portion 13 and an upper part that is continuous with a parting line PL formed along the ridge line 12d. Each parting line PL formed along the ridge line 12d has a length corresponding to one fourth of the entire circumference of the ridge line 12d. A central part in the circumferential direction of the parting line PL formed along the ridge line 12d is continuous with a parting line PL formed on the outer circumferential surface 12b. The four parting lines PL formed on the upper surface 12c extend in the radial direction of the operation member 9 at equal angular intervals in the circumferential direction (only two shown in the perspective view of FIG. 3A). Each parting line PL formed on the upper surface 12c includes a radially outer end, which is continuous with one of two circumferential ends of a parting line PL extending on the ridge line 12d, and a radially inner end, which is continuous with a parting line PL formed on the mounted portion 11 and the knob 10. As shown in FIG. 3D, the region where the upper surface 13a of the slide portion 13 is continuous with the circumferential surface 12b is finely curved. In the same manner, as shown in FIG. 3C, the region where the upper surface 12c is continuous with the outer surface of the mounted portion 11 is finely curved.

In the present example, a recess 16 is formed in the outer circumferential surface 12b of the step portion 12 above two of the thin parts 14. Each recess 16 has a V-shaped cross-section. Two parting lines PL are formed on the outer circumferential surface 12b. These two parting lines PL extend across the recesses 16.

Referring to FIG. 2A, when the knob 10 is rotated, the operation member 9 rotates as the hooks 3f of the hooking portions 3e slide on the upper surface 13a of the slide portion 13. A lubricant is applied between the hooking portion 3e and the outer surface of the slide portion 13, which slides on the hooking portions 3e of the case 3, to reduce friction of the slide portion 13.

The rotation of the knob 10 of the operation member 9 rotates the reduction gear 7. This rotates the internal gear 8, which is engaged with the second gear portion 7b of the reduction gear 7. The rotation of the internal gear 8 pulls a wire of the cable and switches the operation state of the air conditioner.

A method for manufacturing the operation member 9 will now be described.

A mold 20 shown in FIG. 4 is used to integrally mold the operation member 9. The mold 20 includes an outer surface formation mold 21, an inner surface formation movable mold 22, and a fixed mold 23. The outer surface formation mold 21 is cylindrical and has two open ends. The inner surface formation movable mold 22 closes one end (lower end as viewed in FIG. 4) of the outer surface formation mold 21. The fixed mold 23 is partially fitted into the outer surface formation mold 21 and closes the outer end (upper end as viewed in FIG. 4) of the outer surface formation mold 21.

The outer surface formation mold 21 will now be described.

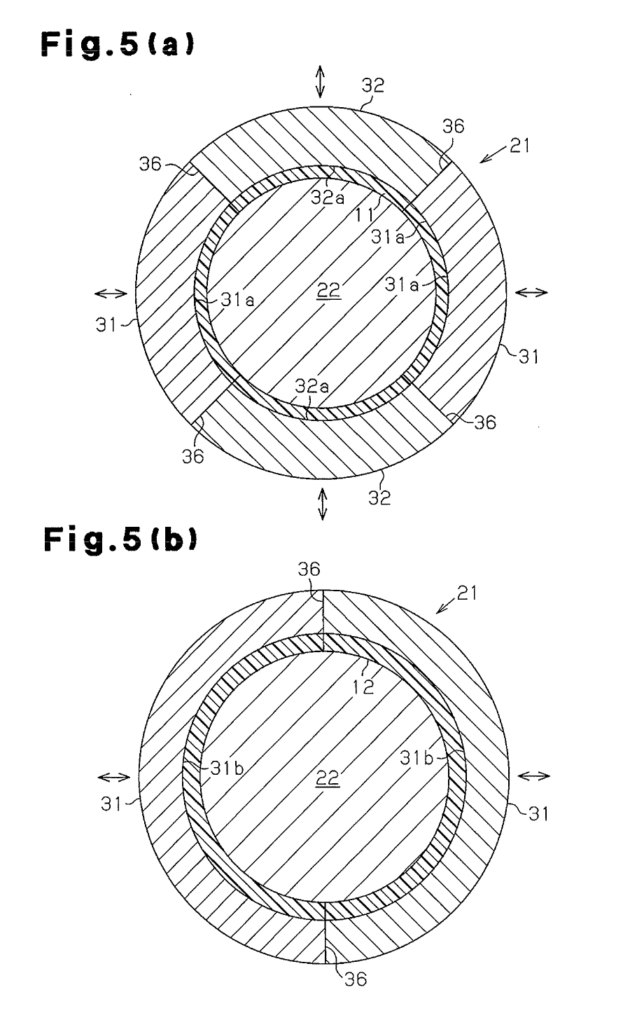

The outer surface formation mold 21 includes a total of four mold segments, namely, two first mold segments 31, which are shown in FIGS. 5A and 5B, and two second mold segments 32, which are shown in FIG. 5B. Each first mold segment 31 includes an upper molding portion 31a, which is shown in FIG. 5A, and a lower molding portion, which is shown in FIG. 5B. As shown in FIG. 4, the upper molding portion 31a includes an inner surface corresponding to the outer circumferential surfaces of the knob 10 and the mounted portion 11. The lower molding portion is formed by a step formation part 31b, which includes an inner surface corresponding to the outer circumferential surface of the step portion 12, and a slide portion formation part 31c, which includes an inner surface corresponding to the outer circumferential surface of the slide portion 13. As shown in FIG. 5A, each second mold segment 32 includes only an upper molding portion 32a. The upper molding portion 32a includes an inner surface corresponding to the outer circumferential surfaces of the knob 10 and the mounted portion 11.

Referring to FIG. 4, the upper molding portions 31a and 32a define a knob formation part 33. The second mold segments 32 and upper molding portion 32a are not shown in FIG. 4. The knob formation part 33 includes a plurality of pyramidal recesses 33a. The two first mold segments 31 include two protrusions 37, which are formed at the middle parts of the step formation parts 31b in the vertical direction at equal angular intervals in the circumferential direction. The protrusions 37 project in an inward direction. Further, the lower ends of the first mold segments 31 includes four partitioning projections 35 (only two shown in FIG. 4) at the lower end of the slide portion formation part 31c at equal angular intervals in the circumferential direction. Each partitioning projection 35 includes an inner surface 35a including an inclined surface gradually inclined inward toward the distal end. Although not shown in FIG. 4, each first mold segment 31 includes a projection arranged at the middle part in the circumferential direction of the lower end of the slide portion formation part 31c. The projection includes an inclined surface inclined gradually inward toward the distal end.

The two first mold segments 31 and the two second mold segments 32 are arranged in contact with one another in the circumferential direction to form the cylindrical outer surface formation mold 21. This forms a single projection at each location where the two first mold segments 32 meet each other. A drive mechanism (not shown) moves the two first mold segments 31 and the two mold segments 32 in the radial direction of the operation member 9 shown by solid lines in FIGS. 5A and 5B. The outward radial movement of one of the two first mold segments 31 separate a circumferential end surface 36 of the first mold segment 31 from the other first mold segment 31 and the two mold segments 32.

As shown in FIG. 4, the two upper molding portions 31a and the two upper molding portions 32a form the outer surfaces of the knob 10 and the mounted portion 11. The recesses 33a of the upper molding portions 31a and 32a form the knurls 10a of the knob 10. Further, the two step formation parts 31b form the outer surface of the step portion 12. The two slide portion formation parts 31c form the outer surface of the slide portion 13. The protrusions 37 of the step portion formation parts 31b form the recesses 16 of the step portion 12. The projection formed by two partitioning projections 35 adjacent to each other in the circumferential direction and formed on the two slide portion formation parts 31c or the projection (not shown) formed on the slide portion formation part 31c forms one of the thin parts 14 of the slide portion 13.

The inner surface formation movable mold 22 will now be described.

Referring to FIG. 4, the inner surface formation movable mold 22 includes a base 41, which has the form of a circular plate, and a mold projection 42, which projects vertically from the upper surface of the base 41 and is fitted to the outer surface formation mold 21.

The base 41 includes an opposing surface 41a opposing the outer surface formation mold 21. The opposing surface 41a comes into contact with the lower end surface of the outer surface formation mold 21 (i.e., the two first mold segments 31), and the base 41 closes the lower opening of the outer surface formation mold 21. The annular part of the opposing surface 41a of the base 41 that does not contact the lower end surface of the outer surface formation mold 21 forms the end surface of the operation member 9 at the side of the slide portion 13.

The mold projection 42 is cylindrical and has a diameter that is smaller than the inner diameter of the outer surface formation mold 21. The projection length of the mold projection 42 from the upper surface of the base 41 is set so that a distal end surface 42a of the mold projection 42 contacts the fixed mold 23 in a state in which the upper surface of the base 41 is in contact with the lower end surface of the outer surface formation mold 21. The inner surface formation movable mold 22 is movable in the vertical direction. A drive mechanism (not shown) moves the inner surface formation movable mold 22 in the downward direction to separate the opposing surface 41a of the base 41 away from the outer surface formation mold 21 and the distal end surface 42a of the mold projection 42 away from the fixed mold 23.

From the upper side, the mold projection 42 is formed by a first step 42b, which corresponds to an inner surface of the knob 10, a second step 42c, which corresponds to an inner surface of the mounted portion 11, a third step 42d, which corresponds to an inner surface of the step portion 12, and a fourth step 42e, which corresponds to an inner surface of the slide portion 13. In this manner, the mold projection 42 has the form of a ladder that includes four steps. The outer circumferential surface of the mold projection 42 forms the inner surface of the operation member 9. In detail, the first step 42b forms the inner surface of the knob 10, the second step 42c forms the inner surface of the mounted portion 11, the third step 42d forms the inner surface of the step portion 12, and the fourth step 42e forms the inner surface of the slide portion 13.

The fixed mold 23 will now be described.

The fixed mold 23 has the form of a circular plate and closes the upper opening of the outer surface formation mold 21. A cylindrical protrusion 23a protrudes from the central part of the lower surface of the fixed mold 23. The protrusion 23a has a larger diameter than the first step 42b. The movable mold contact surface 23b forms the inner surface of the upper part of the knob 10, that is, the part where the knob top 15 is arranged, with the outer circumferential surface of the protrusion 23a and an annular part excluding the part of the movable mold contact surface 23b contacting the distal end surface 42a of the mold projection 42. The fixed mold 23 includes a lower surface defining a mold segment contact surface 23c, which extends around the protrusion 23a. The mold segment contact surface 23c contacts the outer surface formation mold 21 (i.e., end surfaces of the first and second mold segments 31 and 32).

When manufacturing the operation member 9, first, as shown in FIG. 4, the outer surface formation mold 21 (i.e., the two first mold segments 31 and the two mold segments 32) and the fixed mold 23 are brought into contact with the inner surface formation movable mold 22. This forms a cavity having a shape corresponding to the shape of the operation member 9. The cavity includes space for forming the mounted portion 11 of the operation member 9, space for forming the step portion 12, and space for forming the slide portion 13.

Next, an injection apparatus (not shown) injects molten resin into the cavity. The molten resin is hardened. Then, the inner surface formation movable mold 22 is moved in a direction opposite to the projection direction of the mold projection 42, and the first and second mold segments 31 and 32 are moved outward in the radial direction. This allows the operation member 9 to be removed from the outer surface formation mold 21. The operation member 9 includes parting lines PL formed at locations where the upper portions of the first mold segments 31 meet the second mold segments 32 (total of four locations) and locations where the lower portions of the first mold segments 31 meet each other (total of two locations). The molten resin is not filled into parts of the cavity where the partitioning projections 35 and the projections (not shown) are arranged. These parts form the thin parts 14. In the same manner, the molten resin is not fitted into parts of the cavity where the protrusions 37 are arranged. These parts form the recesses 16. The thin parts 14 and the recesses 16 formed by the partitioning projections 35 include the partitioning lines PL. Finally, the operation member 9, which is fixed to the mold projection 42 of the inner surface formation movable mold 22, is moved in the projection direction of the mold projection 42 and removed from the mold projection 42. This forms the operation member 9.

The operation of the operation unit 2 will now be described.

As described above, a lubricant such as grease is applied to the operation member 9 between the outer surface of the slide portion 13 and the hooking portions 3e of the case 3 to reduce friction. The lubricant is transferred along the parting lines PL due to the usage environment, such as the temperature and the humidity.

It is know that a ridge line will hinder the transfer of a liquid such as the lubricant. The lubricant, which is applied to the slide portion 13, is transferred from the slide portion 13 to the knob 10 along the parting lines PL. The step portion 12 is located between the slide portion 13 and the knob 10. As shown in FIG. 3, the parting lines PL are formed along the ridge line 12d at the step portion 12. Thus, the ridge line 12d hinders the transfer of the lubricant. This hinders the advancement of the lubricant toward the mounted portion 11 and the knob 10.

Further, as shown in FIG. 3, the recesses 16 are formed at locations corresponding to the parting lines PL in the outer circumferential surface 12b of the step portion 12. The recesses 16 collect the lubricant transferred from the slide portion 13 along the parting lines PL. In other words, the transfer of the lubricant from the slide portion 13 to the knob 10 along the parting lines PL is suppressed.

The present embodiment has the advantages described below.

(1) The parting lines PL of the slide portion 13 (step portion) are shifted from the parting lines PL of the mounted portion 11 (knob 10) in the circumferential direction at the ridge line 12d. It is well known that a ridge line hinders the transfer of liquid. Thus, the ridge line 12d hinders the flow of the lubricant along the parting lines PL. Further, the transfer of the lubricant from the slide portion 13 to the knob 10 along the parting lines PL is suppressed.

(2) The parting lines PL of the slide portion 13 are shifted from the parting lines formed on the mounted portion 11. The ends of each parting line PL formed on the ridge line 12d connects one end of a parting line PL formed on the slide portion 13 to one end of a parting line PL formed on the mounted portion 11. Thus, the two ends of each parting line PL formed on the ridge line 12d form peaks at where the continuous parting line PL is bent. The peaks hinder the flow of the lubricant along the parting lines PL. Thus, the transfer of the lubricant from the slide portion 13 to the knob 10 along the parting lines PL is suppressed.

(3) Each parting line PL extending upward from the slide portion 13 is branched into two directions at the ridge line 12d. Thus, more parting lines PL are formed at the step portion 12 than the slide portion 13. This increases the paths along which the lubricant is transferred upward in the operation member 9 and increases the amount of lubricant required to be transferred upward. Thus, less lubricant leaks from the paths as compared to when the same amount of lubricant is applied to a slide portion 13 having less paths. Further, the parting lines PL include fine steps. This increases slide resistance when the number of the parting lines PL increases at the slide portion 13. In this respect, the slide portion 13 includes a small number of the parting lines PL. This suppresses the slide resistance at the slide portion 13. Accordingly, the operation unit is easy to operate and lubricant does not leak out of the operation unit.

(4) The corner formed between the upper surface 13a and the outer circumferential surface 12b and the corner formed between the upper surface 12c and the outer circumferential surface of the mounted portion 11 includes curved portions that are finely curved. The curved portions suppress the occurrence of a capillary action. In other words, the curved portions suppress the dispersion of the lubricant.

It should be apparent to those skilled in the art that the present invention may be embodied in many other specific forms without departing from the spirit or scope of the invention. Particularly, it should be understood that the present invention may be embodied in the following forms.

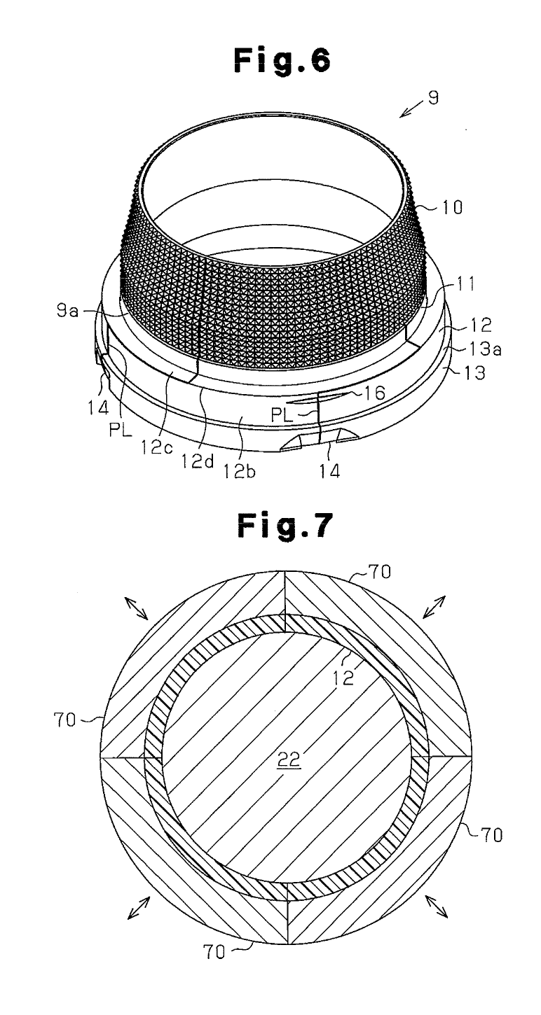

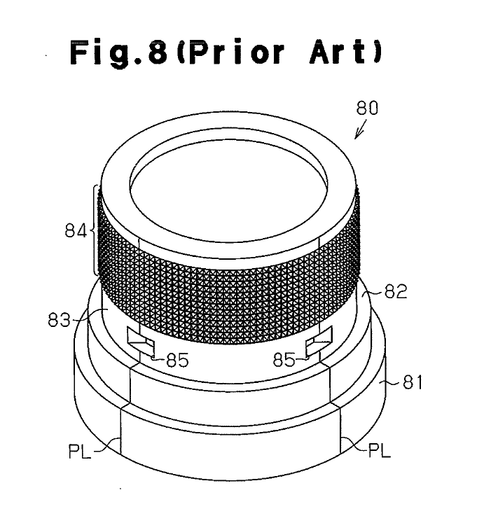

In the above embodiment, the outer surface formation mold 21 includes the first mold segments 31 and the second mold segments 32 that have different shapes. Each parting line PL formed on the outer surface of the operation member 9 is branched into two directions at the ridge line 12d. However, such branching is not necessarily required. For example, as shown in FIG. 6, four parting lines PL may extend from the slide portion 13 to the knob 10 at equal angular intervals in the circumferential direction. The four parting lines PL are shifted by 90° from one another at the ridge line 12d. In this case, as shown in FIG. 7, the outer surface formation mold 21 includes four identical mold segments 70. In comparison with the upper embodiment, this structure decreases the distance in which a drive mechanism (not shown) moves the mold segments 70 when forming the operation member 9. This allows for reduction in size of a machine tool that forms the operation member 9.

In the above embodiment, the parting lines PL are arranged in the ridge lines 12d of the step portion 12 but may be arranged at other locations. For example, a parting line PL may be arranged in the ridge line of the slide portion 13 or the knob 10 of the mounted portion 11. Further, a plurality of parting lines PL may be arranged at these locations. Such a structure would have the same advantages as the above embodiment.

In the above embodiment, the ridge line 12d is formed by a portion at which a peak of 270° continues. However, the peak is not limited to 270° as long as the peak has a major angle of 180° to 360°.

In the above embodiment, the corner between the upper surface 13a and the outer circumferential surface 12b and the corner between the upper surface 12c and the outer circumferential surface of the mounted portion 11 are finely curved but do not have to be curved. Such a structure would still obtain advantages (1) to (3) of the above embodiment.

In the above embodiment, the outer surface of the operation member 9 excluding the slide portion 13, namely, the outer surfaces of the knob 10, the mounted portion 11, and the step portion 12 do not have to be cylindrical. These outer surfaces may be polygonal and include ridge lines. For example, the outer surfaces may be hexagonal or octagonal. In this case, the formation of the parting lines PL on the ridge lines of the polygon will suppress the leakage of lubricant at the knob 10.

In the above embodiment, the thin parts 14 and the recesses 16 are formed during injection molding. However, the thin parts 14 and the recesses 16 may be formed after injection molding the operation member 9 through, for example, machining, grinding, laser processing, thermal processing, or ultrasonic processing. Further, after injection molding the operation member 9, part of the outer surface 9a of the operation member 9 may be eliminated or melted to divide apart the parting line PL.

The above embodiment is applied to an operation unit that rotates the operation member, that is, a rotary switch. However, the present invention may also be applied to an operation unit that pushes an operation member, that is, a push switch, as long as the outer surface of the operation member includes a slide portion and a parting line.

In the above embodiment, the operation unit 2 is used with the air conditioner but may be used for an in-vehicle device such as audio equipment to adjust the volume. The operation unit 2 may also be used as a switch unit for a device other than an in-vehicle device.

The present examples and embodiments are to be considered as illustrative and not restrictive, and the invention is not to be limited to the details given herein, but may be modified within the scope and equivalence of the appended claims.

1. An operation unit comprising:
a case; and
an operation member molded integrally through injection molding, wherein the operation member includes
an outer surface,
a slide portion supported by the case, wherein the slide portion is slidable and movable relative to the case,
a knob operated by an operator,
a parting line formed continuously from the slide portion to the knob along the outer surface, and
a ridge line formed on the outer surface, wherein at least part of the parting line is formed along the ridge line.

2. The operation unit according to claim 1, wherein
the outer surface includes a first outer surface, which is defined on the slide portion, and a second outer surface, which is defined on the knob; and
the parting line includes a first portion, which is formed on the first outer surface of the slide portion, a second portion, which is formed on the second outer surface of the knob, and a third portion, which is formed along a first portion of the ridge line located between the first portion and the second portion.

3. The operation unit according to claim 2, wherein the parting line includes a fourth portion, which is formed at a location that differs from the second portion formed on the second outer surface of the knob, and a fifth portion, which is formed along a second portion of the ridge line located between the first portion and the fourth portion.

4. The operation unit according to claim 2, wherein the first portion of the parting line is shifted in a circumferential direction of the operation member from the second portion of the parting line.

5. The operation unit according to claim 1, wherein
the operation member includes a step located between the slide portion and the knob, and
the step forms the ridge line.

6. The operation unit according to claim 1, wherein
the operation member includes a recess formed in the outer surface, and
at least part of the parting line extends across the recess.
